(19) United States
(12) Patent Application Publication
(10) Pub. No.: US 2021/0248278 A1
(43) Pub. Date: Aug. 12, 2021

(54) PROCESS ARCHITECTURE MODELING PLATFORM

(71) Applicant: Intelligent System, Inc., San Francisco, CA (US)

(72) Inventor: Cris Padmore Solomon, Tiburon, CA (US)

(21) Appl. No.: 16/788,610

(22) Filed: Feb. 12, 2020

(51) Int. Cl. G06F 30/12; G06F 30/13; G06F 30/20; G06F 3/0484; G06F 3/0482

(52) U.S. Cl. CPC G06F 30/12; G06F 30/13; G06F 2111/16; G06F 3/04845; G06F 3/0482; G06F 30/20

(57) ABSTRACT

A method includes providing, to a client device for display, a GUI comprising a process architecture modeling interface. The method further includes generating, in response to a request, a process architecture model to be displayed on the process architecture modeling interface. The method further includes assigning a value and relationship identifier to a first component of the model, wherein the relationship identifier identifies the relationship of the first component of the model to a second component of the model. The method further includes providing the first component, second component, value, and relationship identifier for display on the client device. The method further includes executing a simulation of the model, based on the first component, the second component, the value, and the relationship identifier and providing a result of the simulation to the client device for display on the process architecture modeling interface.

### TECHNICAL FIELD

Aspects of the present disclosure relate to modeling platforms and, more specifically, relate to processing architecture modeling platforms.

### BACKGROUND

Business process modeling (BPM) is the activity of representing processing of an enterprise, organization, or other group so that the process can be analyzed, improved, and automated. Techniques to model business processes are traditionally cumbersome, and generally require specialized knowledge of both business practices and software development. Business process modeling notation (BPMN), or business process modeling languages, exist to aid business analysists create business process models that include a variety of data collection, analysis, and reporting capabilities.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 depicts a first high-level component diagram of an illustrative example of a computer system architecture, in accordance with one or more aspects of the present disclosure.

FIG. 2 depicts a second high-level component diagram of an illustrative example of a computer system architecture, in accordance with one or more aspects of the present disclosure.

FIG. 3 is a block diagram of an example information model, in accordance with one or more aspects of the present disclosure.

FIG. 4 is a flow diagram of a method illustrating user interface navigation, in accordance with some embodiments of the present disclosure.

FIGS. 5A-C illustrate example user interfaces, in accordance with some embodiments of the present disclosure.

FIG. 6 illustrates a component definition interface, in accordance with some embodiments of the present disclosure.

FIG. 7 illustrates as component details interface, in accordance with some embodiments of the present disclosure.

FIG. 8 illustrates a component definition interface with details panel, in accordance with some embodiments of the present disclosure.

FIG. 9 illustrates a design model interface, in accordance with some embodiments of the present disclosure.

FIG. 10 illustrates a design model interface with selecting object to add to model panel, in accordance with some embodiments of the present disclosure.

FIG. 11 illustrates a design model interface with model information panel, in accordance with some embodiments of the present disclosure.

FIG. 12 illustrates an alternate design model interface, in accordance with some embodiments of the present disclosure.

FIG. 13 illustrates a design model interface with universe editing panel, in accordance with some embodiments of the present disclosure.

FIG. 14 illustrates a universes conceptual example, in accordance with some embodiments of the present disclosure.

FIG. 15 illustrates a universes realization example, in accordance with some embodiments of the present disclosure.

FIG. 16 illustrates a universes creation interface, in accordance with some embodiments of the present disclosure.

FIG. 17 illustrates a universes dimension interface, in accordance with some embodiments of the present disclosure.

FIGS. 18A-B, 19, and 20A-B illustrate additional universes dimension interfaces, in accordance with some embodiments of the present disclosure.

FIG. 21 illustrates a universe rule editor interface, in accordance with some embodiments of the present disclosure.

FIG. 22 illustrates a universe rule selector interface, in accordance with some embodiments of the present disclosure.

FIG. 23 illustrates an execution jobs interface, in accordance with some embodiments of the present disclosure.

FIG. 24 illustrates an example project interface, in accordance with some embodiments of the present disclosure.

FIG. 25 illustrates a company groupings interface, in accordance with some embodiments of the present disclosure.

FIGS. 26A-C illustrate time manager interfaces, in accordance with some embodiments of the present disclosure.

FIG. 27 is a flow diagram of a method illustrating process architecture modeling platform operations, in accordance with some embodiments of the present disclosure.

FIG. 28 is a block diagram of an example apparatus that may perform one or more of the operations described herein, in accordance with some embodiments.

### DETAILED DESCRIPTION

Aspects of the present disclosure relate to process architecture modeling platforms. A variety of tools of the modeling platform described herein speed up discovery, documentation, and analysis of client technology operations, as well as provide risk management governance and compliance programs. Advantageously, the embodiments described herein allow clients to model key processes graphically in a manner that is natural and closely mirrors how those processes exist in the real world; as actors that interact with each other, may have complex behaviors, and may be governed by a universe of common rules and shared information.

In one embodiment, after client processes are defined in the platform (e.g., in a model), they may be executed individually or with a range of varying parameters, including historical data. The resulting data may then be analyzed.

In one embodiment, the operations described above may include: providing, to a client device for display, a GUI comprising a process architecture modeling interface; generating, in response to a request, a process architecture model to be displayed on the process architecture modeling interface; assigning a value and relationship identifier to a first component of the model, wherein the relationship identifier identifies the relationship of the first component of the model to a second component of the model; providing the first component, second component, value, and relationship identifier for display on the client device; executing a simulation of the model, based on the first component, the second component, the value, and the relationship identifier; and providing a result of the simulation to the client device for display on the process architecture modeling interface.

Advantageously, the embodiments described herein not only provide an efficient and straightforward solution for user operators, they also improve functionality of underlying computer systems by improving memory usage and processor efficiency.

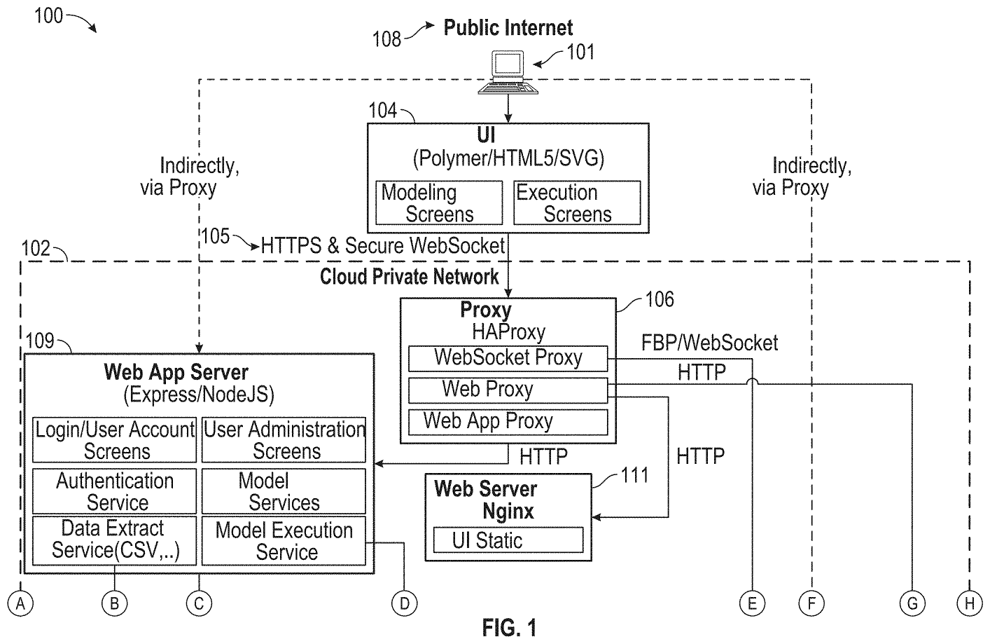

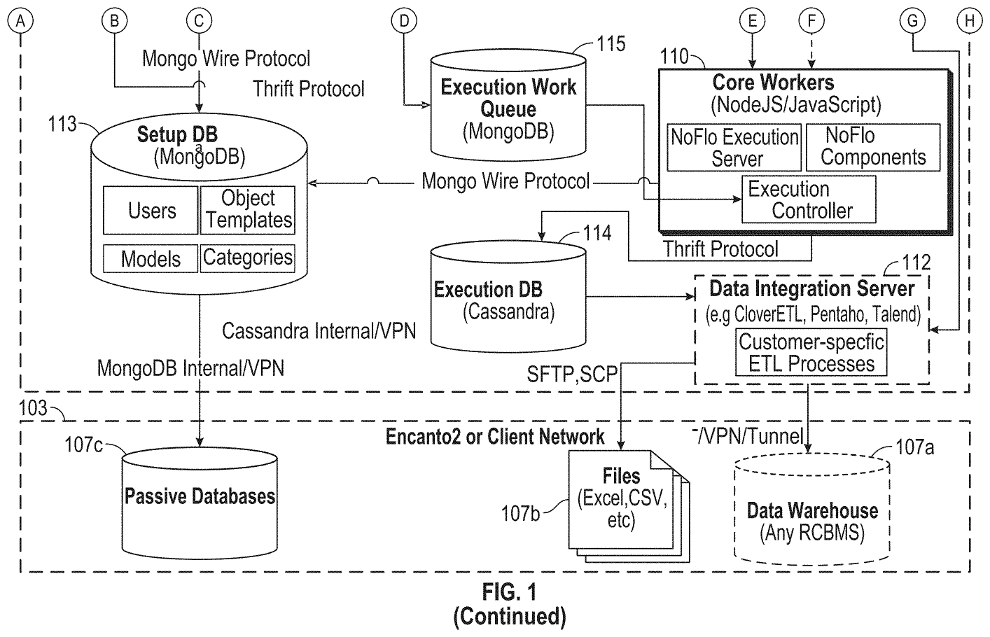

FIG. 1 depicts a first high-level component diagram of an illustrative example of a computer system architecture 100, in accordance with one or more aspects of the present disclosure. One skilled in the art will appreciate that other computer system architectures 100 are possible, and that the implementation of a computer system utilizing examples of the invention are not necessarily limited to the specific architecture depicted by FIG. 1.

In one embodiment, computer system architecture 100 includes a client device 101, cloud private network 102, and client network 103. Each of the components, such as the devices and networks described in FIG. 1, may include their own subcomponents. In other embodiments, alternative architecture is possible that includes more or less components than those illustrated in FIG. 1. In one embodiment, any of the components or subcomponents of FIG. 1 may include one or more processing devices (e.g., central processing units, graphical processing units, etc.), main memory, which may include volatile memory devices (e.g., random access memory (RAM)), non-volatile memory devices (e.g., flash memory) and/or other types of memory devices, a storage device (e.g., one or more magnetic hard disk drives, a Peripheral Component Interconnect [PCI] solid state drive, a Redundant Array of Independent Disks [RAID] system, a network attached storage [NAS] array, etc.), and one or more devices (e.g., a Peripheral Component Interconnect [PCI] device, net, which based serve as data storage for a source code repository) work interface controller (NIC), a video card, an I/O device, etc.). In certain implementations, main memory may be non-uniform access (NUMA), such that memory access time depends on the memory location relative to processing device.

The client device 101, cloud private network 102, and client network 103 may include a server, a mainframe, a workstation, a personal computer (PC), a mobile phone, a palm-sized computing device, etc. Architecture 100 may additionally include one or more virtual machines (VMs).

In one embodiment, a user interface 104 of client device 101 communicates with cloud private network 102 via a secure Web Socket 105, or any other suitable communication protocol. In other embodiments, client device 101 may communicate indirectly to a variety of components of cloud private network 102 via proxies (e.g., proxy 106).

In one embodiment, architecture 100 servers reside within a cloud private network 102 that is isolated from other cloud servers or the internet (e.g., only proxy 106, running the HAProxy, is directly exposed to the Internet). In addition to the cloud private network 102, some components of the architecture 100 may reside in other networks. For example, client network 103 may be a disaster recovery site and site for offsite backup. In another embodiment, client network 103 may include an extract, transform, and load (ETL) server that extracts cloud private network 102 data into client data warehouses or files (e.g., 107a, 107, b, 107c).

In one embodiment, proxy 106 is a front-end for all requests to other servers in the cloud private network 102. The proxy 106 may serve a variety purposes. For example, proxy 106 may isolate the rest of the cloud private network 102 from the public internet 108. Proxy 106 may terminate HTTPS and WebSocket Secure (WSS) connections 105 from the browser (e.g., on client device 101) and other clients. The remaining servers in the cloud private network 102 may then communicate without encryption. In one embodiment, proxy 106 may act as a proxy for exposed services hosted in the webapp server 109. In another embodiment, proxy 106 proxies FBP Web Socket connections to core workers 110. In another embodiment, proxy 106 may load balance requests to other servers (e.g., for databases which may not load balance via other means), and maps requests to the appropriate internal server.

In one embodiment, the user interface (UI) 104 may be a collection of screens and UI components based on HTML5, and the Google Polymer framework. From a user experience perspective, the UI 104 may include: screens to define, browse, and update models; NoFlo-based screens to graphically visualize and manipulate models; and screens to browse models and object templates based on category. In some embodiments, UI 104 may further include execution screens to: define universe parameters for execution; initiate execution and monitor progress, and download an Excel extract of model execution results. In one embodiment, models, as described herein, are process architecture models, designed to imitate real-world process flows.

In one embodiment, the UI 104 is actually a set of static web resources (HTML, CSS, images) and Polymer-based JavaScript code that gets downloaded and executed on the user's browser (e.g., on client device 101). The UI 104 only needs to communicate with the server to fetch new data or push data updates to the server. Advantageously, this may enable the UI 104 to be much more responsive and efficient over traditional server-based web applications. In one embodiment, login, user management, and other UI screens may be provided by the webapp server 109. In one embodiment, UI 104 may be based on: HTML5, Polymer, NoFlo UI, or any other suitable technology.

In one embodiment, webapp server 109 may include: user authentication services, login and user administration screens, and role and attribute-based access control management screens. In other embodiments, webapp server 109 may include services used by the client 101 browser, including: model services for searching, retrieving, and saving models; model execution services for managing model execution jobs, searching and retrieving information on past executions; and simple data extract services for extracting model execution data as CSV and other formats. In one embodiment, webapp server 106 may be based on a NodeJS web application server running on top of JavaScript runtime, express web framework, and/or a Passport security framework. In other embodiments, any other suitable technologies may be utilized.

In one embodiment, core workers 110 may be responsible for the actual execution of models based on requests posted by the model execution services in the webapp server 109. In one embodiment, the execution controller of core workers 110 pulls execution requests from a publish/subscribe topic whenever it is ready for more work. Advantageously, using a publish/subscribe topic allows the number of workers to be scaled up on-demand, and the work to be distributed among them dynamically. In one embodiment, core workers may be based on a NoFlow executution engine, and a NodeJS platform. In another embodiment, any other suitable technology may be used.

Worth noting, although in the architecture 100, only the core workers 110 are shown with multiple server instances, in fact all servers in the architecture 100 support clustering and load balancing. This includes the web server 111, applications (e.g., NodeJS-based), and each database.

In one embodiment, web server 111 may serve static content, including the UI 104 code, and cache static content. In one embodiment, web server 111 may be based on Nginx technology, including additional suitable Nginx modules. In another embodiment, any other suitable technology may be utilized.

In one embodiment, data integration server 112 may be responsible for extracting data from the various databases that are part of the architecture 100, translating the data, and writing it out to various targets, including: files (Excel, CSV, XML, etc) 107b to be downloaded via the UI 104; files (Excel, CSV, XML, etc) 107b to be transmitted to client networks via VPN/SCP/SFTP; and data warehouses 107a via VPN, to be used in further analysis and reporting. In one embodiment, the data integration server may be based on CloverETL, Pentaho, Talend, or any other suitable technologies.

In one embodiment, the setup DB 113 may be based MongoDB, or any other suitable technology, and may contain the following types of data: user login and profiles; models; company custom components; and company groupings. In one embodiment, the setup DB (and any other databased in architecture 100) may deployed across at least three servers in order to be fault tolerant to a single server failure, and to have enough members to elect a new primary. In other embodiments, any other number of servers may be used.

In one embodiment, execution DB 114 may be based on Apache Cassandra, or any other suitable technology, and may contain data from model execution runs. In one embodiment, the execution DB 114 is deployed across at least three servers to be able to handle more load, and for fault tolerance. In other embodiments, any other number of servers may be used.

In one embodiment, execution work queue 115 stores to-be-processed execution requests, initiated either from the UI 104 or scheduled to be run in the future. In one embodiment, the requests are pulled from the queue 115 and processed by core workers 110 as possible depending on the number of core workers 110 that are available. In one embodiment, the execution work queue 115 supports peeking into the queue 115 for the number of outstanding requests in the queue 115, and the size of the requests. Advantageously, this allows architecture 110 to dynamically increase the number of core worker 110 servers based on the amount of work in the queue 115, then decrease the number of servers after the work in the queue 115 has returned to a threshold level.

In one embodiment, passive databases 107c may be employed to be replicas of the production setup 113 and execution databases 114, and may be used to take snapshot backups, and to populate databases in a disaster recovery scenario.

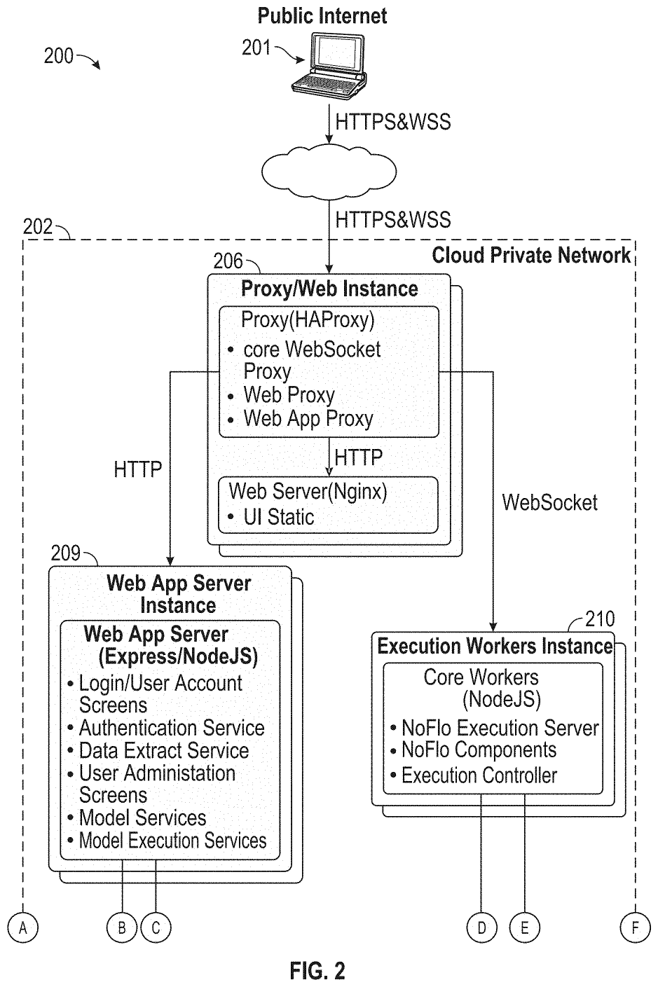

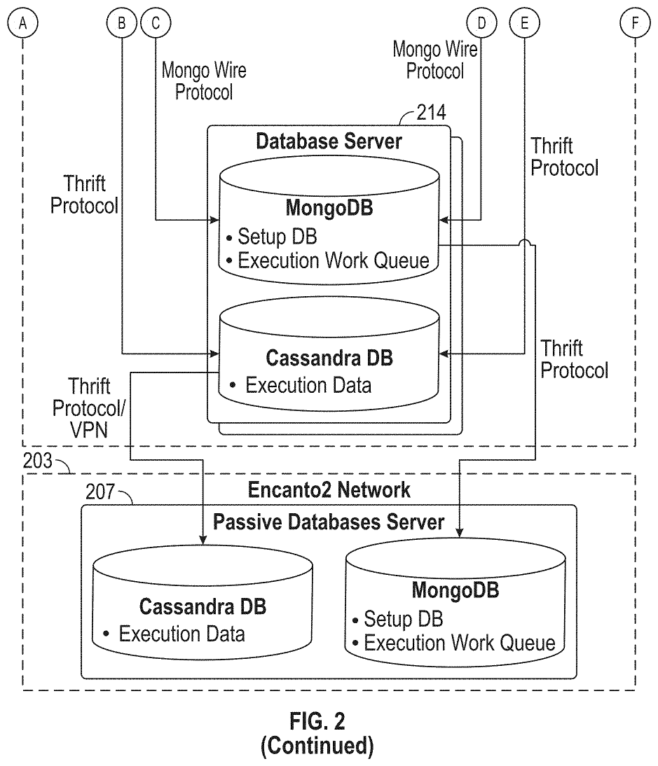

FIG. 2 depicts a second high-level component diagram of an illustrative example of a computer system architecture 200, in accordance with one or more aspects of the present disclosure. One skilled in the art will appreciate that other computer system architectures 200 are possible, and that the implementation of a computer system utilizing examples of the invention are not necessarily limited to the specific architecture depicted by FIG. 2.

In one embodiment, computer system architecture 200 represents a physical architecture platform for the embodiments described herein, where System Components, represented as white boxes, are allocated to cloud server instances, represented as green boxes. In one embodiment, for each type of instance, there may be at least two instances for fault tolerance and to distribute load. The number at the top right of each type of instance may indicate the number of cloud server instances in an example production deployment. Worth repeating, any other suitable number of instances may be utilized by architecture 200.

In general, the components of architecture 200 may be the same or different components as those specified with respect to architecture 100 of FIG. 1. For example, client device 201, cloud private network 202, proxy/web instance 206, webapp server instance 209, execution workers instance 210, database server 214 client network 203, and passive databases server 207 may correspond to, or be instantiated by, client device 101, cloud private network 102, proxy 106, webapp server 109, execution workers 110, execution database 114, client network 103, and passive databases server 107c of FIG. 1.

In one embodiment, the architectures 100 and 200 of FIG. 1 and FIG. 2, respectively, are capable of disaster recovery (e.g., including automatic disaster recovery). For example, in the event of an outage affecting the cloud hosting region hosting the platforms corresponding to architectures 100 and 200, a recovery process may include the following high level steps:
1. Create a new set of servers within the cloud hosting provider in an unaffected region.
2. Update the disaster recovery domain name to point to the new Proxy/Web Instance.
3. Run the automated server provisioning scripts to install software and configure the servers as needed.
4. Configure Cassandra and MongoDB databases (e.g., 114/214) on the new servers to replicate from the passive databases (e.g., 107/207). In one embodiment, this can be done automatically by the server provisioning scripts above.
5. Deploy the same version of code to the new servers as was on the old servers.
6. Wait for replication from the passive databases to complete.
7. Execute automatic and manual application readiness tests to ensure all functionality is working at a basic level.
8. Communicate to clients they can resume using the platform using the disaster recovery URL.
   In one embodiment, a different cloud hosting provider for the disaster recovery site may be utilized to mitigate the risk that the outage affects all regions of the cloud hosting provider. In one embodiment, reduce the running time of step 6, an alternative is to have passive databases (e.g., 107/207) hosted on the disaster recovery region. If and when the disaster recovery region is needed, it will be able to replicate from the passive databases (e.g., 107/207) to the new database servers much more quickly since they are in the same network.

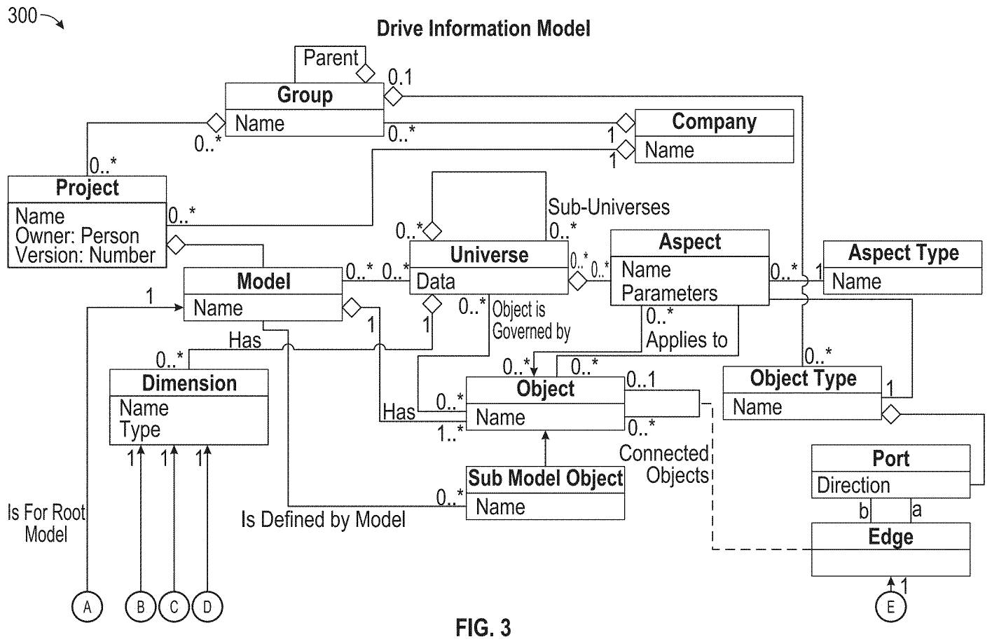

FIG. 3 is a block diagram of an example information model 300, in accordance with one or more aspects of the present disclosure. In one embodiment, model 300 depicts the various types of information elements within the platform described herein, and their relationships to each other. In one embodiment, the following terms may be used with respect to the architecture, platforms, and methods described herein.
Company (aka Client): A company, or other organization using X services. A single client may have multiple users registered with X.
Group: Aka Grouping, Category. A means to organize projects, object templates, and other information within the platform. Groups are defined by company users, and may contain other Groups, thereby supporting hierarchical organization.
Dimension: A measure or value that is global to a universe, and may affect the behavior of the objects within that model, e.g., time and temperature.
User: An individual within a client that is authorized to use X on the client's behalf
Object/component: An element within a model that has:
   any number of inputs (aka precursors) from other objects
   any number of outputs to other objects
   configuration parameters, defined during model creation
   internal state (aka attributes)
   behavior that determines how it reacts to inputs based on its internal state and parameters, and generates outputs. Some objects may also react based on time (e.g. timers).
Object Type: A template for the definition of objects. An object type may define the behavior for objects based on it.
Message: Information that passes between objects via their output and input ports. Messages may have attributes of their own.
Project: One or more models that are interrelated and may be executed together.
Model: A set of objects, connected together, and configured with specific parameters. A model should be defined within a project.
Model Instance: A model that is executing, with messages flowing through it, and internal state in its objects.
Universe: A shared context among one or more objects and zero or more sub-universes. This shared context may include:
   Aspects that may affect object inputs or outputs; and
   Dimension values
Alternate Universes: (aka Multiverses, alternate realities) One or more model instances, of the same or differing models. Each universe has its own set of dimensions. The model instances in alternate universes may interact with each other via messages
Root Object: Object that has no precursors and can initiate a process, by generating an output to one or more downstream objects.
Execution Job: Information on a Model to be executed or that has been executed, including dimension parameter values. The Execution Job does not include the results of Model execution; that is stored within the Execution Run.
Execution Run: The results of an executed job, including captured message values and dimension values over the full course of the model execution.

Notably, the definitions provided above are merely examples. Other suitable definitions are contemplated.

A variety of security measures may be utilized by the embodiments described herein. For example, users may be authenticated in the platform via form-based login. In one embodiment, the user security credentials, login ID, and password, are managed and stored by the platform. Users may be authorized within the platform applications using fine-grained permissions that map up to the following roles: Platform Super User—Can do anything across the system, including adding new companies; Super User—Can do anything within a company; Admin—Can administer other users within a company, but not themselves; Modeller—Can create and modify models, and can execute models; Model Runner—Can execute models, but not modify them; and Read Only—Can only view models and execution results.

In one embodiment, Roles can be specific to a company, Application (e.g. e.g., software of the platform described herein), and group (a.k.a. Function, Category). For example: Jane is a Modeller for the group “Finance”, and can create and modify models within that group or any sub-groups, but not the group “Factory.” Bob is an Admin for the company XYZ.

In one embodiment, in addition to role-based authorization, projects may be marked as private, in which case they are only viewable and editable by the owner of the project, or a Super User. In yet another embodiment, the owner of the project may mark/unmark the project as private.

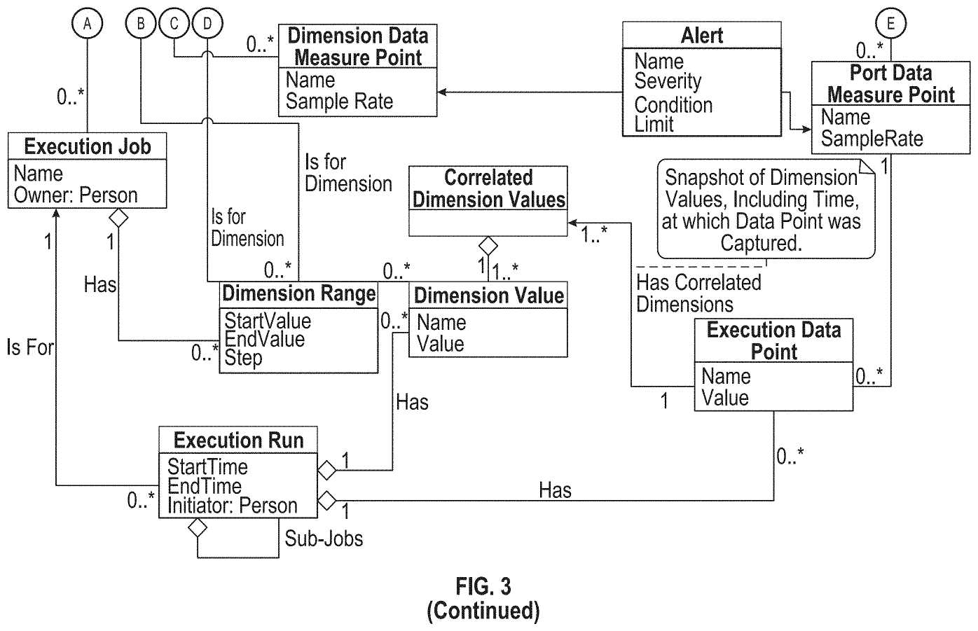

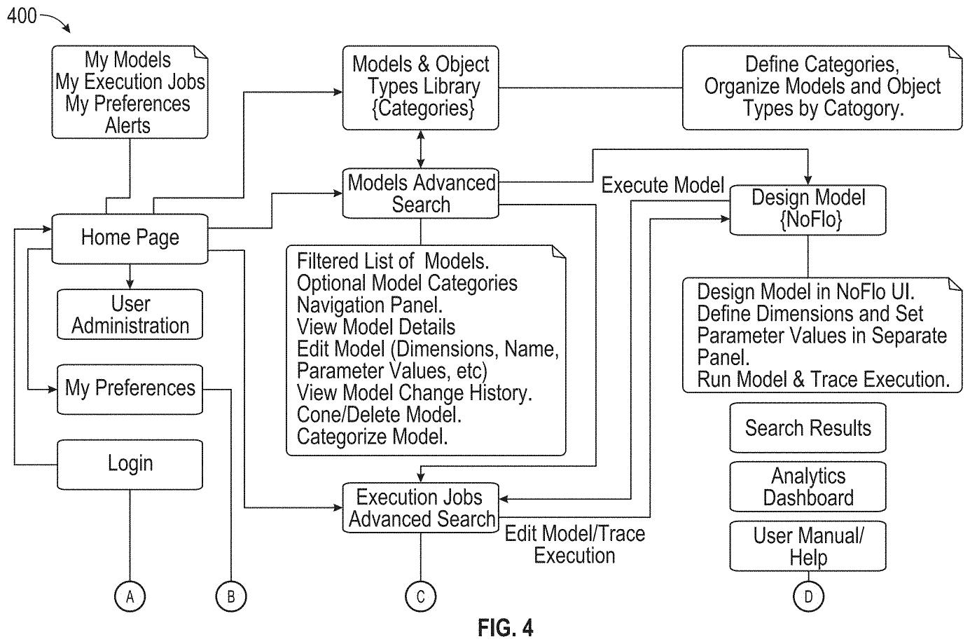

FIG. 4 is a flow diagram 400 of a method illustrating user interface navigation, in accordance with some embodiments of the present disclosure. The method 400 may be performed by processing logic that comprises hardware (e.g., circuitry, dedicated logic, programmable logic, microcode, etc.), software (e.g., instructions run on a processing device to perform hardware simulation), or a combination thereof. In embodiments, aspects of method 400 may be performed by architecture 100 of FIG. 1 (e.g., on client device 100).

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

In one embodiment, information within the described platform may be organized into hierarchical groups, which may be defined on a per-organization basis. They are a method to organize or categorize information such as models and object templates in a way that makes sense to the organization. Groups can be used to represent, for example: a company's organization structure (e.g. divisions, departments) and job functions within a company. In one embodiment, groups may be defined within a web application corresponding to the platform, rather than the platform itself, because groups may be used across multiple applications and are not specific only to a single platform.

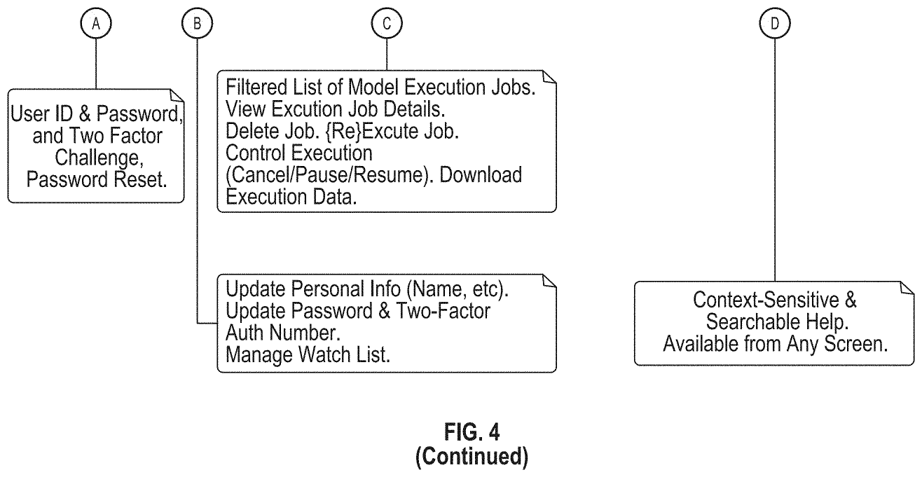

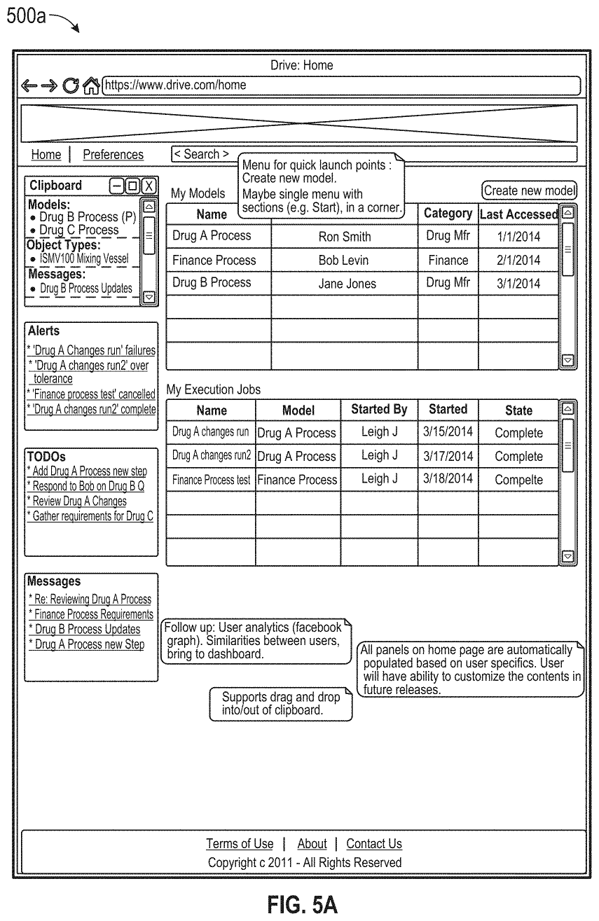

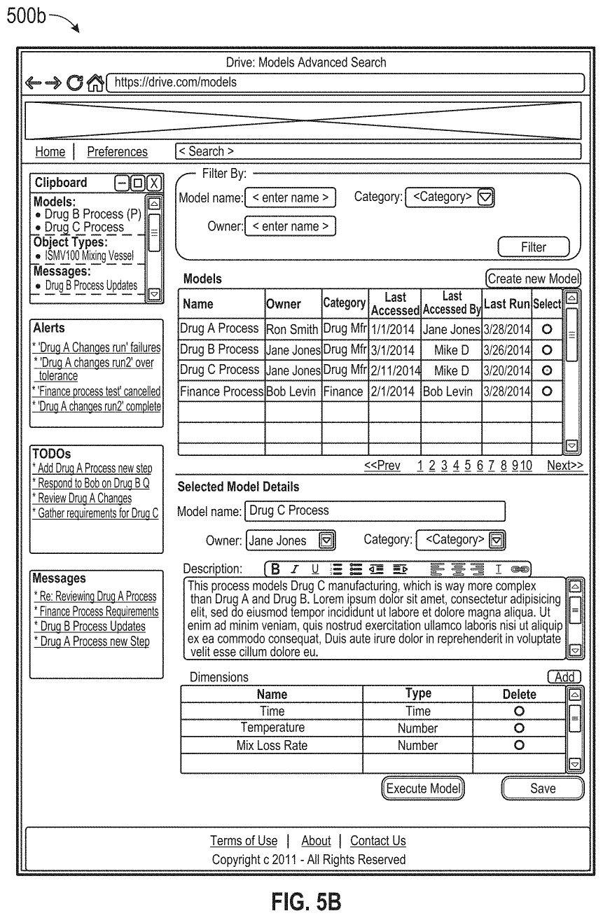

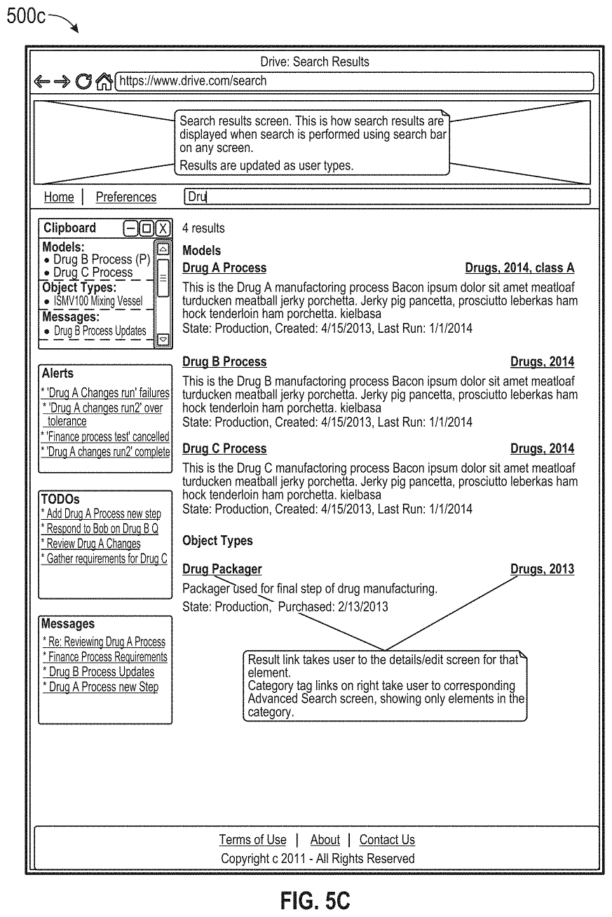

FIGS. 5A-C illustrate example user interfaces 500a, 500b, and 500c, in accordance with some embodiments of the present disclosure. For example, FIG. 5A illustrates an example home screen 500a, FIG. 5B illustrates an example advance search screen 500b, and FIG. 5C represents an example simple search screen 500c.

In one embodiment, before a user may start defining models, they may define the components, or object types, that are used in their organization that will form the building blocks of their models. Users can define their own components using a variety of techniques. In one embodiment, users may define components by graphically creating a model that represents the component's behaviors, inputs, and outputs. This may be used by more advanced users in cases where they need detailed control of how the component behaves. In another embodiment, components may be defined by selecting the set of behaviors that the component should have from an available menu, from which the described platform will build a custom component meeting the specifications.

In one embodiment, once the component is defined, whatever technique is used, may be saved in the company's library, and may then be used in models. Components in the library may be assigned a grouping to be able to organize components.

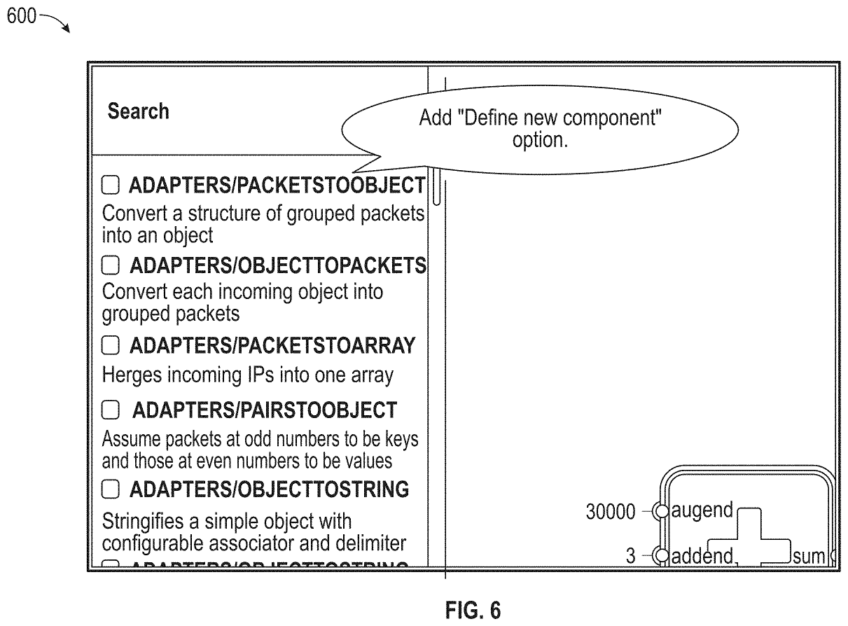

A component definition interface 600 is illustrated in FIG. 6. In one embodiment, the component definition interface 600 is used to define components, whatever technique is used. The component definition interface 600 may be reached from the model definition screen, by clicking on “Define new component” in the component search. In one embodiment, the component definition interface opens as a separate window so the user may see their model at the same time they are defining the new component.

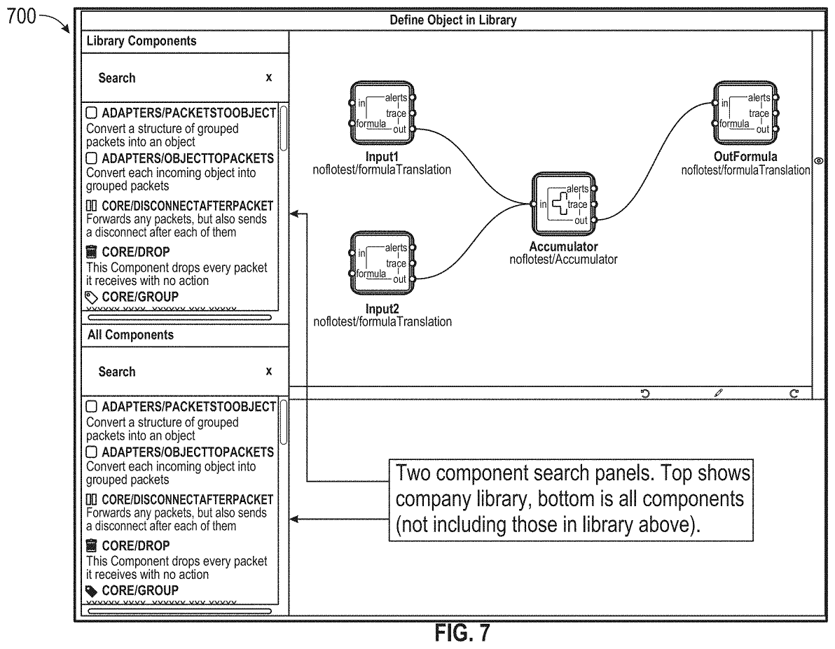

In one embodiment, the component definition interface 600 may contain the following elements: a component library search element in the top left. This is similar to the component search in the model definition screen, except it is always present and open to its full size; an all component search element in the bottom right, which is also always present and open. In one embodiment, this list only includes components not in the component library search above; a graph editor panel where the component may be designed. This is the same as the graph editor used in the model definition screen; the inspector “eye” icon on the right opens the component details panel, which is described with respect to FIG. 7; a cancel button that allows the user to discard any changes they made and not update the component library; and an “Update Library” button that updates the component library with whatever changes they have made.

FIG. 7 illustrates as component details interface 700, in accordance with some embodiments of the present disclosure. In one embodiment, if a user clicks on the “eye” inspector icon on the right side of interface 600, processing logic opens a panel from the right showing component details, including the component behaviors, which are the other way to define the component other than drawing the graph manually.

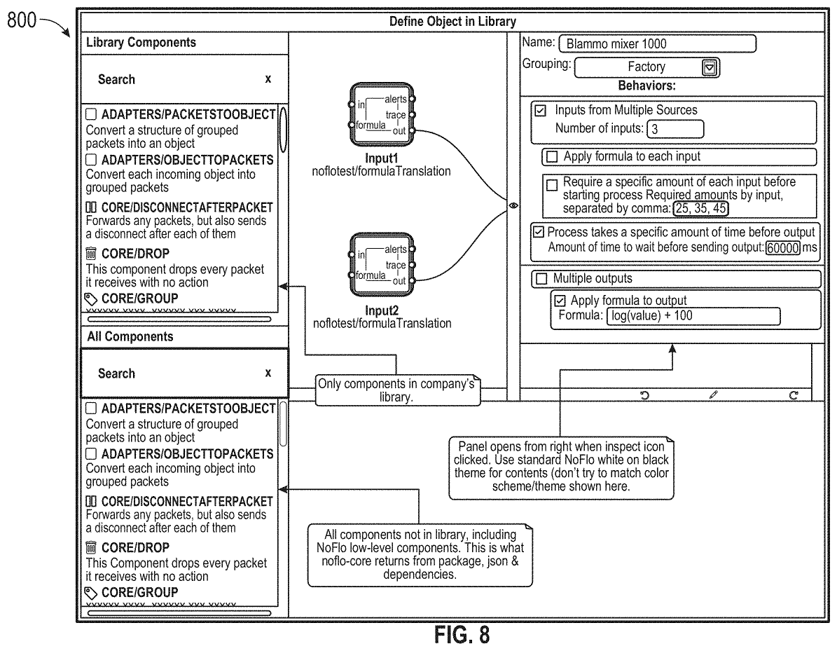

FIG. 8 illustrates a component definition interface 800 with details panel, in accordance with some embodiments of the present disclosure. In one embodiment, the details panel may include the following elements and functionality: allows the user to view and edit the component name and grouping, both of which may be mandatory; the panel may follow the same theme as the rest of the platform UI; panel opens from the right similar to other panels in the platform UI. In one embodiment, if the user has manually edited the graph, the behaviors are all cleared. If the user changes something in the behaviors section, the panel validates the entry, and if valid, re-generates the graph, updates it so the user may see the changes, and automatically lays out the graph. In one embodiment, the behaviors are divided into three sub-sections including inputs, core behaviors, and outputs.

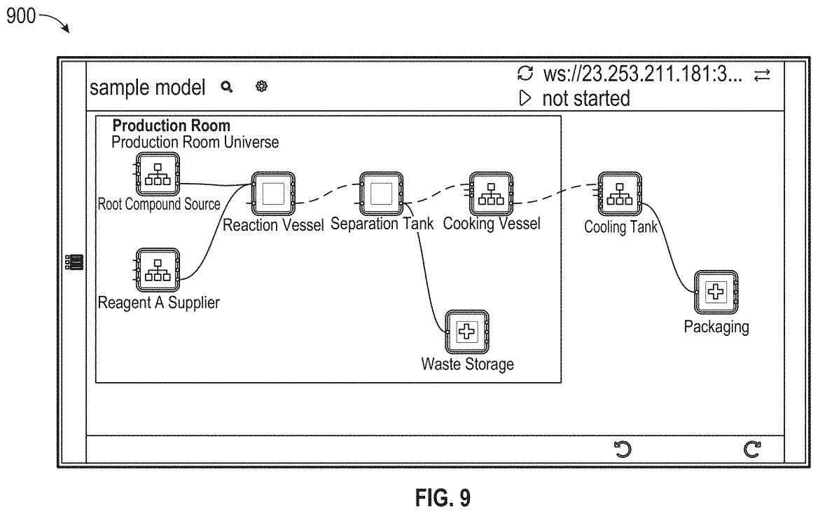

FIG. 9 illustrates a design model interface 900, in accordance with some embodiments of the present disclosure. In one embodiment, the described platform allows users to define models graphically; adding objects and manipulating them within a model on a graphical canvas. Models can become large and complex, making them difficult to work with. To manage this complexity, the embodiments described herein support defining models that are composed of other nested models. The nested models may appear as components in the containing model. FIG. 9 illustrates a model with multiple objects connected together, and a Universe “Production Room” encompassing several objects.

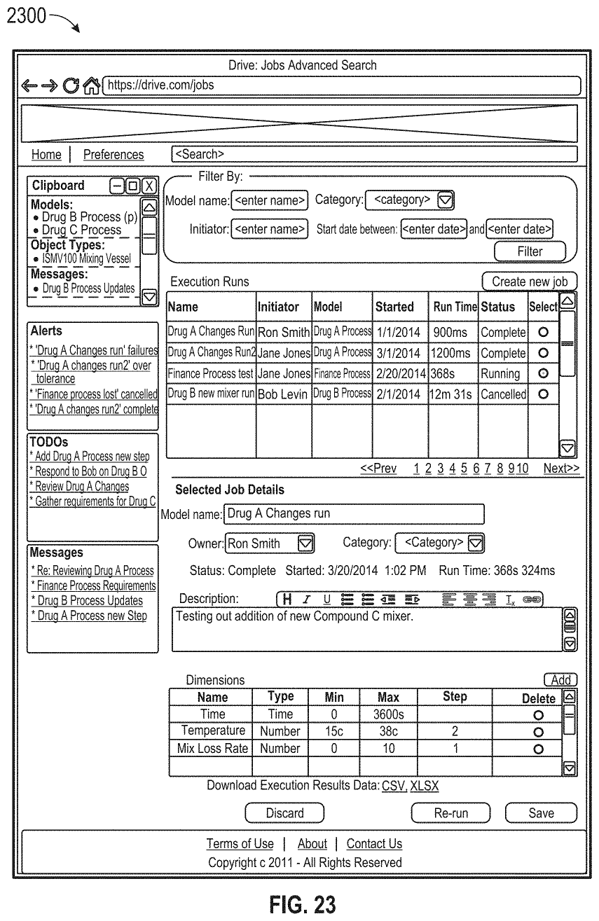

In one embodiment, users may execute models on the Design Model interface 900. Users may also execute models via the Execution Jobs feature described with respect to FIG. 23, which may be intended for large execution runs, taking a longer time to execute, with the option to schedule the execution to run in the future. In one embodiment, model execution on the Design Model interface 900 may include the following features: data flowing across the connected objects may be traced in real time; objects with alerts are visually highlighted on the model; and the model may be stopped and started interactively; The running state of the model may be saved to the database. The user may then restore a running model from the database, and the model will resume execution where it left off.

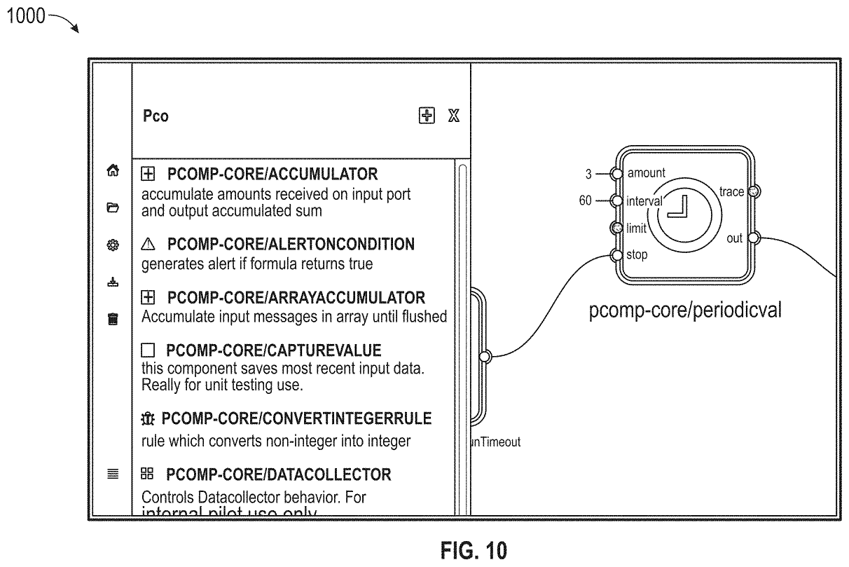

FIG. 10 illustrates a design model interface 1000 with selecting object to add to model panel, in accordance with some embodiments of the present disclosure. More specifically, FIG. 10 illustrates an object being added to the current model by searching the available object types.

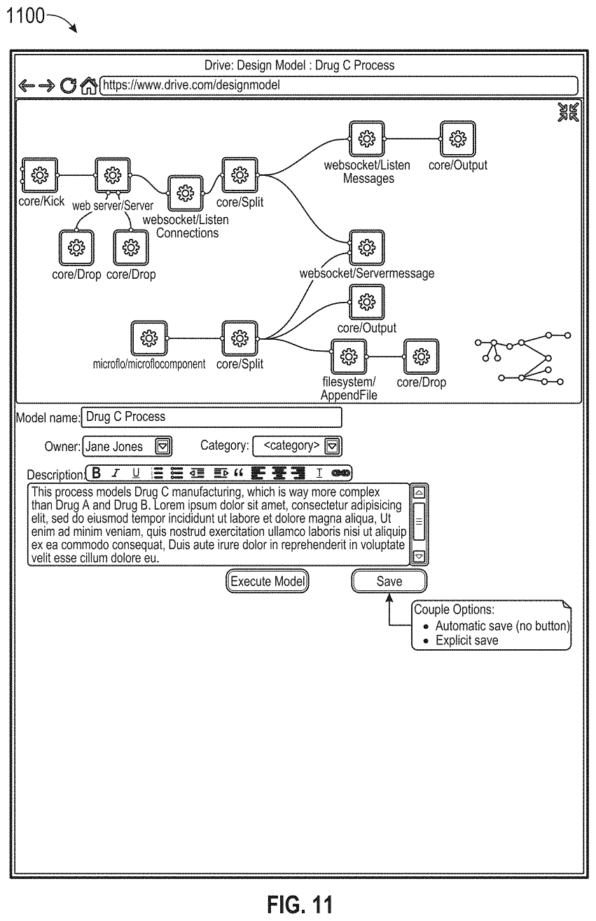

FIG. 11 illustrates a design model interface 1100 with model information panel, in accordance with some embodiments of the present disclosure. In one embodiment, the model information panel may allow a user to view and edit the model name, description, owner, and other metadata, as shown.

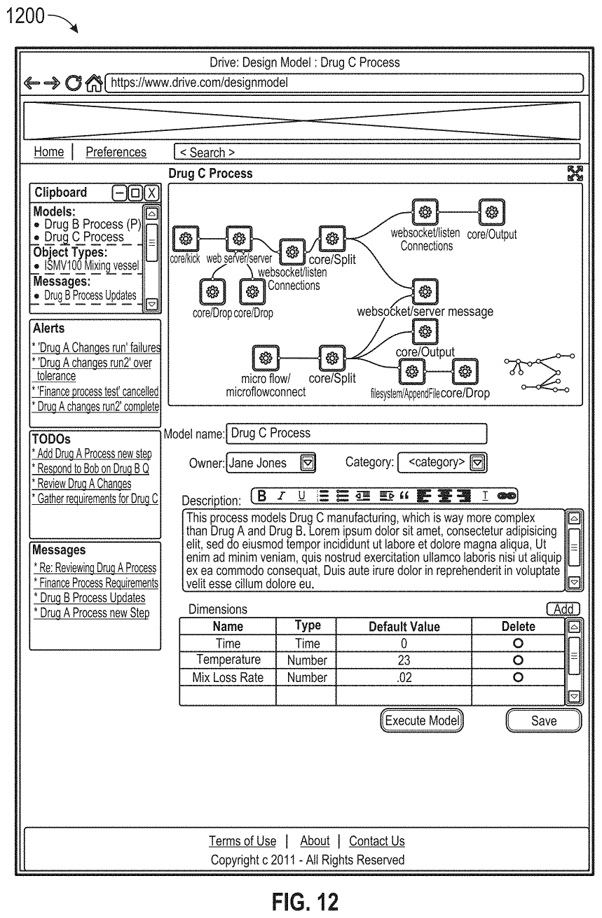

FIG. 12 illustrates an alternate design model interface 1200, in accordance with some embodiments of the present disclosure. In one embodiment, 1200 illustrates an alternate view of the Design Model screen, that de-emphasizes the graphical view of the model to display other model attributes and related information.

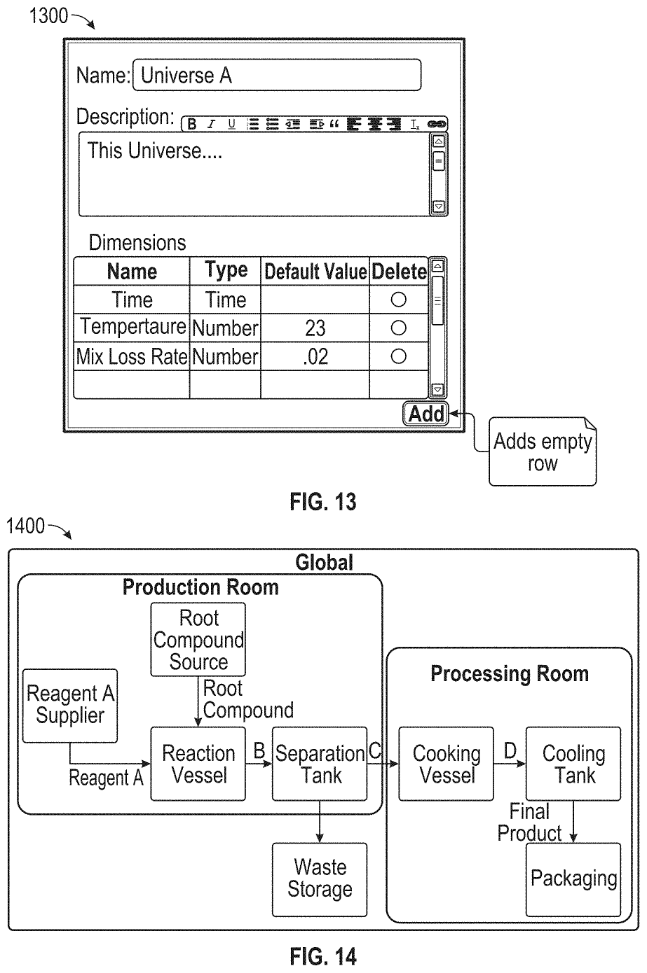

FIG. 13 illustrates a design model interface 1300 with universe editing panel, in accordance with some embodiments of the present disclosure. In one embodiment, 1300 illustrates a panel that allows a user to view and edit Universe details. This panel may be displayed when a user selects a Universe in the Model. In one embodiment, Universes are shared contexts between one or more objects that may share data with those objects, and may have rules that govern how those objects interact.

FIG. 14 illustrates a universes conceptual example 1400, in accordance with some embodiments of the present disclosure. Example 1400 is non-limiting, and is provided below. Three universes are shown, with each universe having different sets of objects they govern. Production Room and Processing Room each have their own set of objects within them they govern, and the Global Universe encompasses every object in the model and the Production Room and Processing Room sub-universes.

Each universe has some shared information which may be updated by its objects, and is made available to its objects for their internal use. For example, each of the Production Room and Processing Room universes above may have an ‘ambientTemperature’ data element that is available to any component in each universe. These data elements that are global within the Universe are not represented in the graph, but are part of the Universe itself and available to any component. As described herein, these Universe-global data elements may be called Dimensions, and a user may be presented the choice of showing or hiding them in the graph.

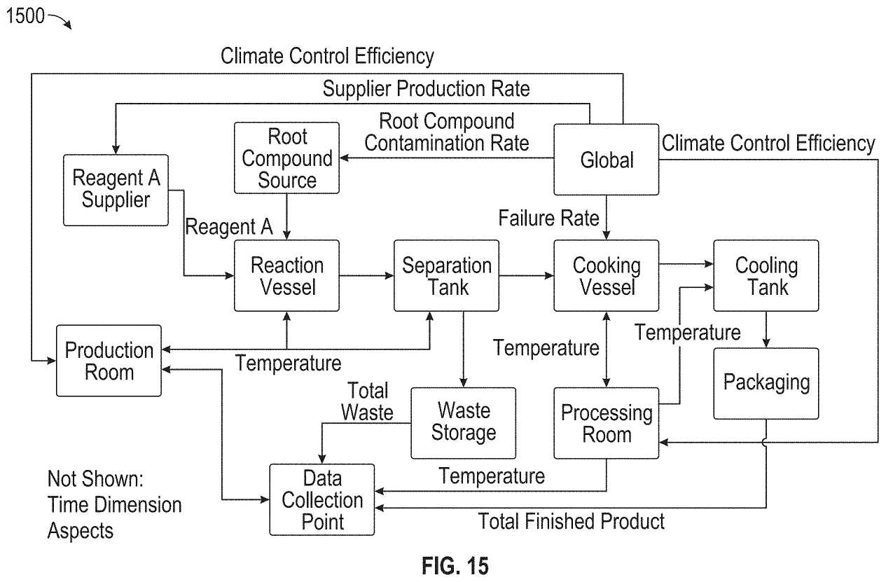

FIG. 15 illustrates a universes realization example 1500, in accordance with some embodiments of the present disclosure. FIG. 15 illustrates how the previous conceptual example of a Model with Universes (e.g., 1400) is internally realized in the described platform.

The Production Room, Processing Room, and Global Universes may be objects in the model that are connected to the objects they govern and have to pass information to and from. For example, the Production Room Universe exchanges room ambient temperature information with several objects, and receives the climate control efficiency value from the Global Universe. Referring to FIG. 15, each Universe manages its information (e.g. ambient temperature), and exchanges them with the components that use it.

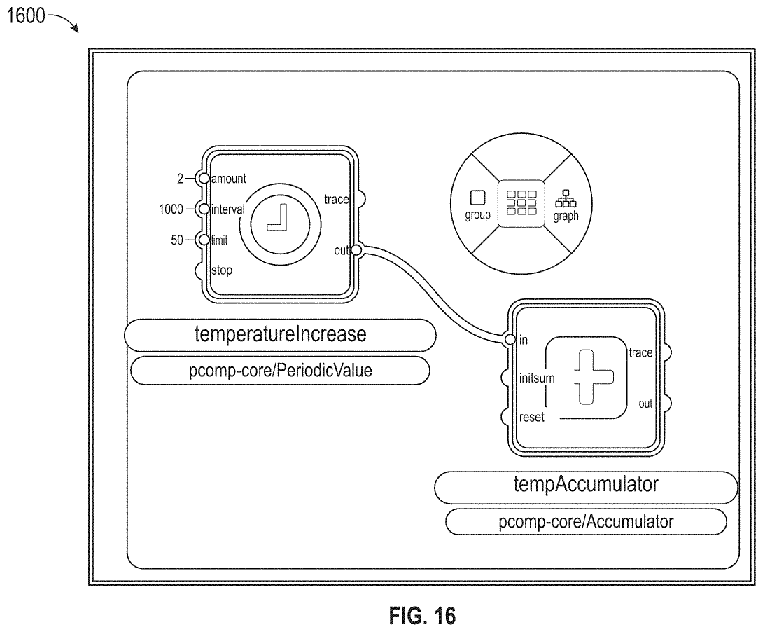

To create a Universe, a user may select one or more components in a graph, then right click in the open space inside the selection box around the components, and select “group,” as illustrated in FIG. 16.

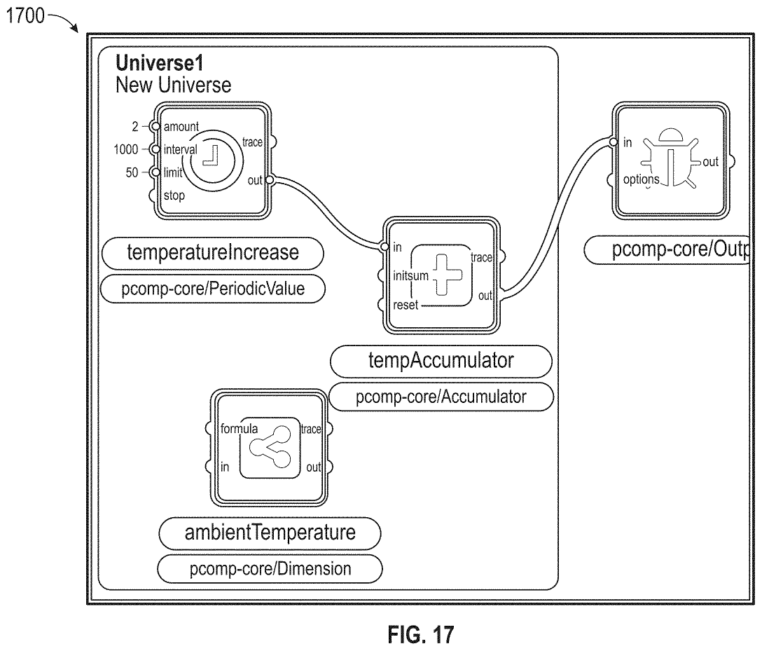

In one embodiment, dimensions are data elements that are global within the Universe, and available to any component inside the Universe. They may be a way to represent data that isn't local to one component, and needs to be more widely used by the components in the Universe. In one embodiment, Dimensions are represented as components within the Universe, but may be hidden. To add a Dimension to a Universe, a user may select the Dimension component via the component search in the top left, and add it to the graph, as shown in FIG. 17. Once it has been added to the graph, a user may select the Universe and the new Dimension component, then right click on the Dimension and select “+ group.” The user may now name the Dimension as you would any other component. In one embodiment, the name of the Dimension is the name to be used to access the dimension value in formulas.

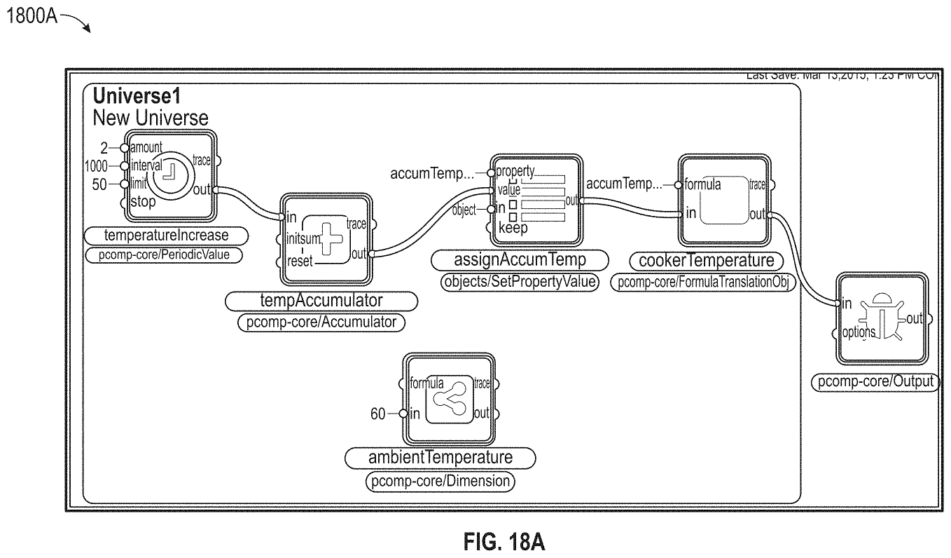

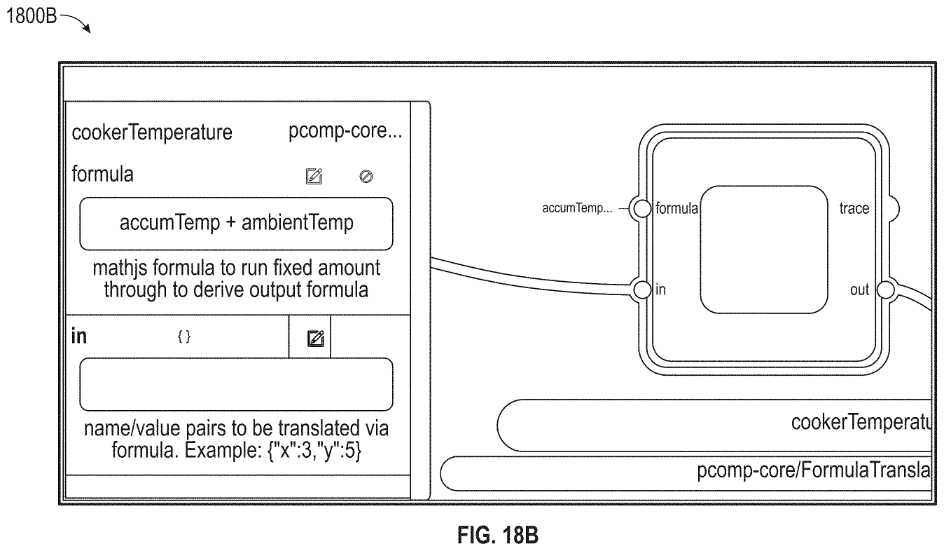

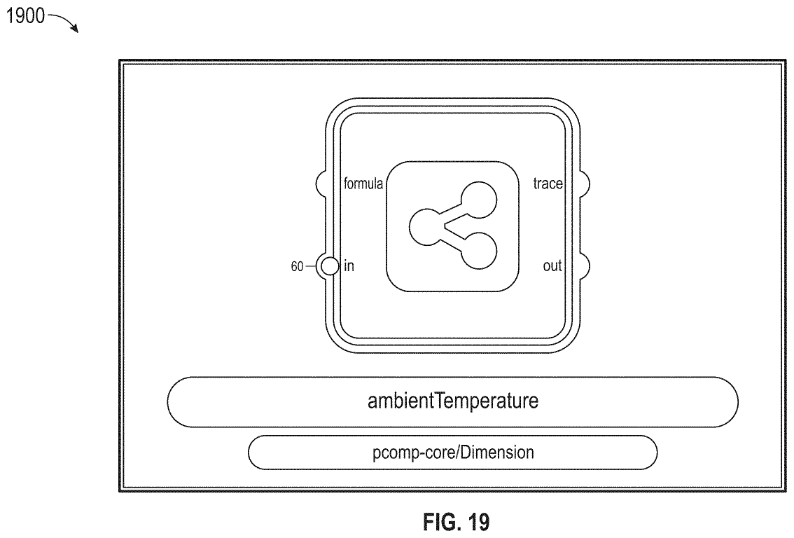

Once added to the Universe, the dimension value may be available in any formulas within the Universe. For instance, in the following example, the FormulaTranslationObj ‘cookerTemperature’ (FIG. 18A) has the ‘accumTemp’ that comes over its ‘in’ port available to it, as well as the ‘ambientTemperature’, although that isn't connected. The ‘cookerTemperature’ formula in the left side panel is illustrated in FIG. 18B.

In one embodiment, Dimension values may be set by sending a value into its ‘in’ port. In the simple example illustrated in FIG. 19, the platform set the ambientTemperature to 60 and it never changes because a hard-coded IIP (initial information packet) was used. The Dimension component may also support setting the value by evaluating a formula. In one embodiment, the formula has available to it the following variables: input—The last value received on ‘in’; prev—The previous value of this dimension. This can be useful to set the new dimension value based on some formula taking into account the previous dimension value; universe—The Universe, from which the formula can access any other Dimension value via the ‘dimension’ function.

In the example illustrated by FIG. 20A, the ambientTemperature is set by applying a formula that uses the cookingTemperature as an input. The formula is visible in the left side panel that appears when a user selects the Dimension component. A user may also explicitly wire a Dimension out to other components, so whenever the Dimension is updated, it sends the value to other components. In the simple example illustrated by FIG. 20B, whenever the ambientTemperature is updated, the value is sent to an Output component.

In addition to its other functions, Universes may be a conduit for components in the Universe to access external data. Following are examples of data that Universes can make available to its components: Data from big data sources (e.g. Hadoop); Relational databases (e.g., Oracle RDBMS); and Data from prior Encanto execution runs. In other embodiments, any other suitable data may be made available to universe components.

In simulations, may be desirable to evaluate a part of a model multiple times in parallel with varying combinations of parameters. The results of these parallel evaluations may be stored in the database for later analysis, or may be used in the model itself to select those evaluations that meet some criteria. On the described platform, this may be supported by an Alternate Universes feature. Using the Alternate Universes feature, the objects in the Universe may be evaluated in parallel with varying combinations of dimension values. Users may specify the range of values for each dimension using a mathematical function and parameters. The data generated by each parallel evaluation may be stored in the database and can be extracted for later analysis. The results of the Alternate Universes evaluations may be fed into other objects in the model to select the evaluation(s) that meet some criteria.

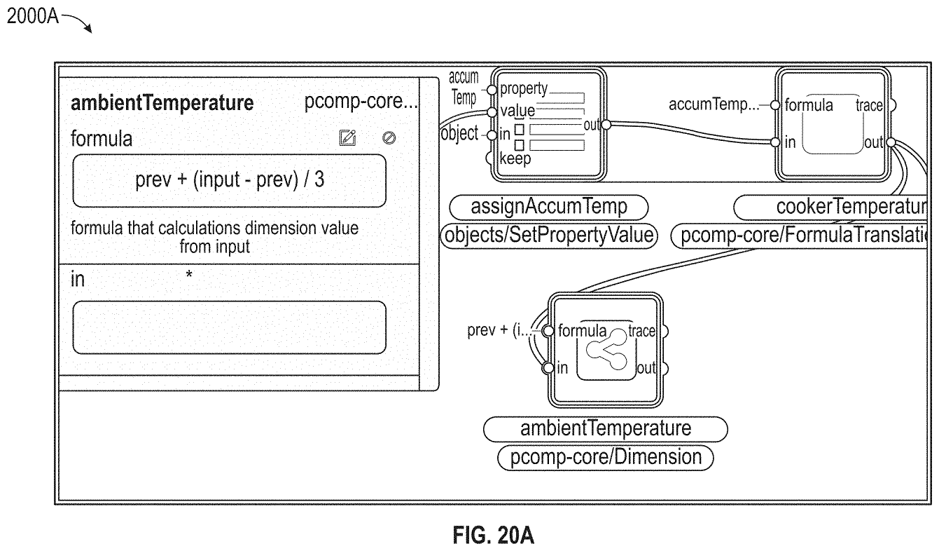

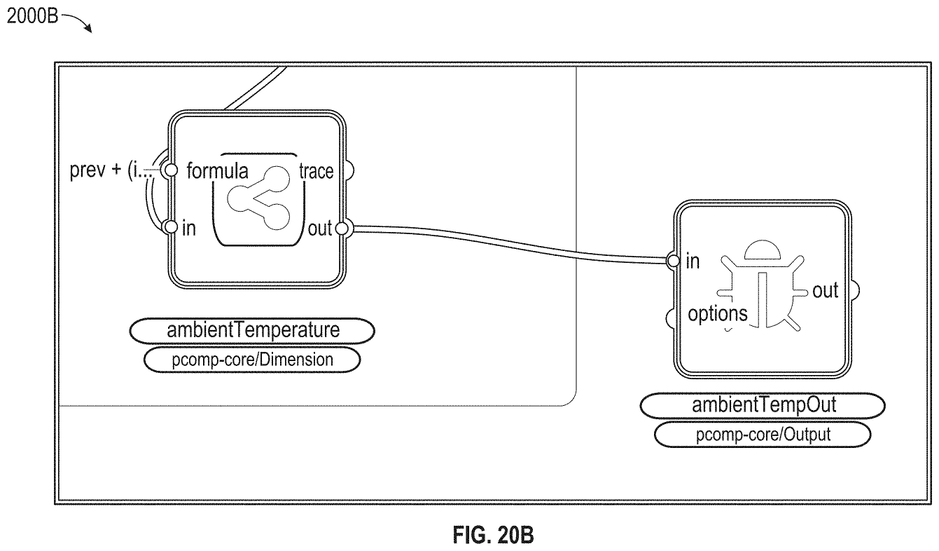

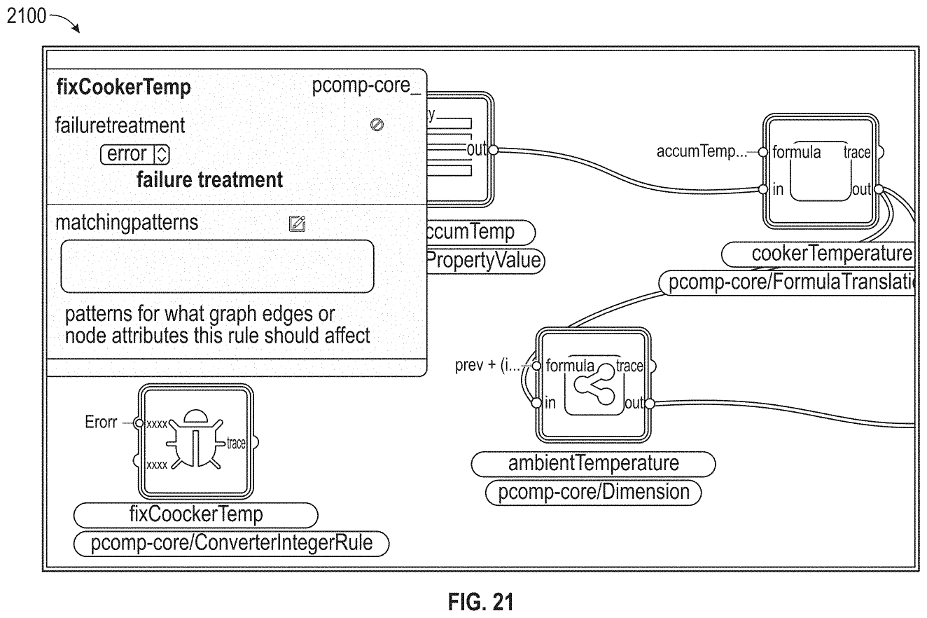

FIG. 21 illustrates a universe rule editor interface 2100, in accordance with some embodiments of the present disclosure. In one embodiment, Universe Rules is a feature closely tied to Universes, that allows data passing between objects in a Universe to be intercepted, and conditionally ‘fixed.’ For example, a rule might be configured to intercept all numerical data flowing between objects in the Universe, and change any imaginary numbers into non-imaginary numbers. This may be used to compensate for formulas in a model that can sometimes incorrectly yield imaginary numbers. Universe Rules may be represented as components in the graph, which may optionally be hidden. For instance, the 2100 of FIG. 21 shows a ConvertlntegerRule, ‘fixCookerTemp’ in a Universe.

Using the Universe Rule editor interface 2100, a user may set the ‘matchingpatterns’ to select what inputs and outputs the rule should be attached to. Whenever an input is received on a chosen port, the rule is activated and will intercept the value coming across the edge, and may forward the value, modify it, or suppress it, depending on the behavior of the rule.

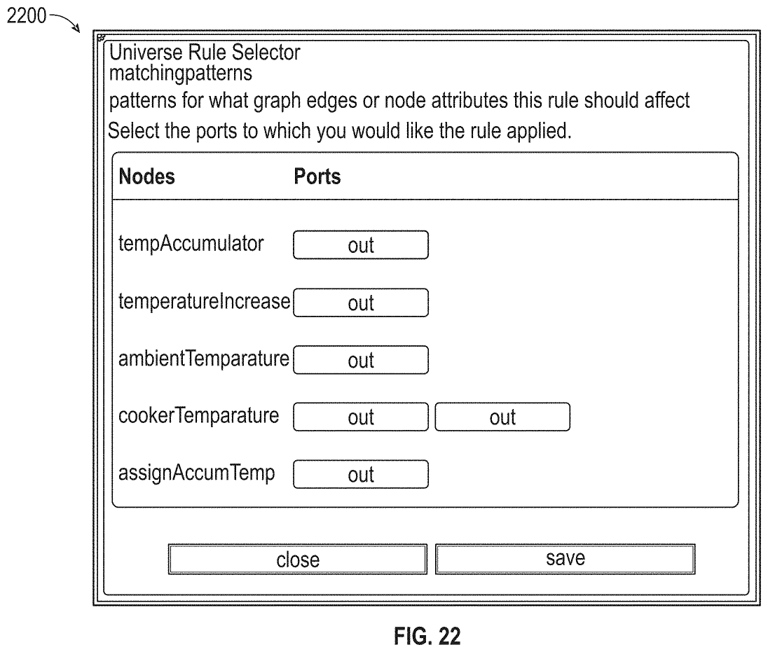

FIG. 22 illustrates a universe rule selector interface 2200, in accordance with some embodiments of the present disclosure. In the example illustrated by FIG. 22, the convert integer rule is intercepting any values from the cookerTemperature component out port, and will convert any non-integer values into integers, and forward the result to ambientTemperature and the output component. In a variety of embodiments, additional universe-related features are contemplated. For example, parent, child, and sibling universes accessing each other's dimension values, rules that attach to edges in graph or sub-graphs based on a pattern or some condition, rules attaching to edges in sub-graphs, rules triggering off and updating dimension values, rules triggering off and updating component internal attributes, etc. are possible on the described platform.

FIG. 23 illustrates an execution jobs interface 2300, in accordance with some embodiments of the present disclosure. The Execution Jobs feature may be used to manage prior execution runs, and to trigger new execution runs. Execution runs may be triggered any of the following ways: executed interactively on the Design Model interface; executed on the Execution Jobs Screen; and on a scheduled basis as defined on the Execution Jobs Screen.

FIG. 23 illustrates the Execution Jobs screen, where a user may: define execution jobs to execute a Model immediately or in the future; define execution parameters for the execution job; search for past execution runs; and review the results of past execution runs.

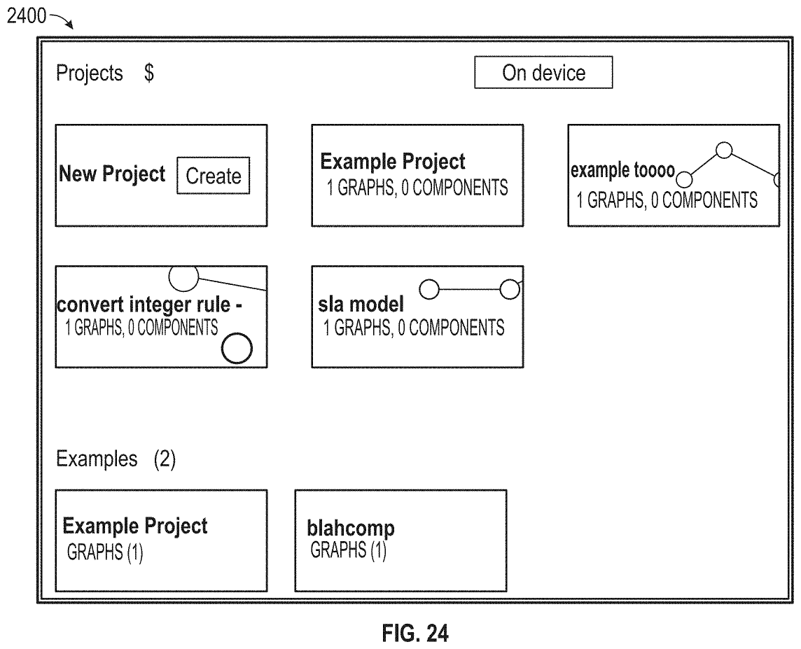

FIG. 24 illustrates an example project interface 2400, in accordance with some embodiments of the present disclosure. In one embodiment, the described platform comes with some example projects which illustrate the types of models that may be created within the platform. These models may be fully functional and may be executed. The example projects may include a good representation of the various types of components and features available within the platform. In one embodiment, the example projects are displayed on the main platform UI screen, beneath the projects that are stored on the device, as illustrated in FIG. 24.

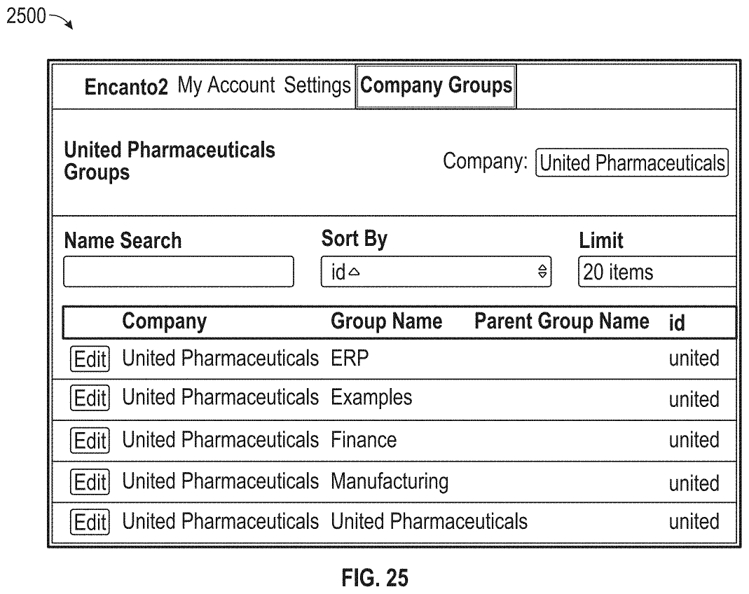

In addition, organizations may customize their example projects, making them specific to their organization. This can be done by saving projects under the special “Examples” grouping. The available groupings within a company may be found in the Company Groupings screen 2500, as illustrated in FIG. 25.

In one embodiment, when executed, the models described herein may have information flowing between objects and Universes. All of this information may be captured by the described platform for later analysis. Advantageously, the platform allows for an individual piece of data flowing at a point of time between one object and another be presented in such a way that provides meaningful context for analysis. Specifically, the platform may attach every piece of data generated within a model execution to Correlated Dimension Values. In one embodiment, Correlated Dimension Values may be the values of all the Universe Dimensions at the instant that the data element was generated. An example of this may be illustrated with respect to FIG. 14. Referring to FIG. 14, Time, Ambient Temperature, and Finished Product Price may be Dimensions, whose values vary over the course of execution. Cooking Vessel Temperature and Total Finished Product Amount (g) may be example data flows between objects that were correlated to the current Dimension values. A corresponding, non-limiting, example sample data extract may be as follows:

| | | | | | Total |
|---|---|---|---|---|---|
| | | | Finished | Cooking | Finished |
| | | Ambient | Product | Vessel | Product |
| | Time | Temperature | Price | Temperature | Amount |
| Universe | (ms) | (c.) | ($) | (C.) | (G) |
| 1 | 0 | 23 | 40 | 30 | 0 |
| 1 | 500 | 23 | 40 | 32 | 0 |
| 1 | 1000 | 23 | 40 | 34 | 0 |
| 1 | 1500 | 23.1 | 40 | 37 | 100 |
| 1 | 2000 | 23.3 | 40 | 38 | 100 |
| 1 | 2500 | 23.6 | 40 | 40 | 200 |
| . . . | | | | | |
| 2 | 0 | 20 | 45 | 45 | 0 |
| 2 | 500 | 20 | 45 | 45 | 0 |
| . . . | | | | | |

In one embodiment, the described platform supports alerts that are used to signal conditions in a model meeting some criteria. Alerts may have the following characteristics: alerts may be defined on objects, attributes, outputs, and dimensions; alerts may be defined using flexible mathematical expressions that may depend on multiple variables. In one embodiment, if the expression evaluates to true, an alert is generated; alerts may have different levels of severity: informational, warning, severe, failure; and objects with active alerts may be visually highlighted when running a model in the platform Design Model screen.

In one embodiment, when an alert is raised, it may be routed to multiple consumers, including: full details on each alert may be stored in the database along with the other model execution data; and external systems, via RESTful web services, or via a messaging system

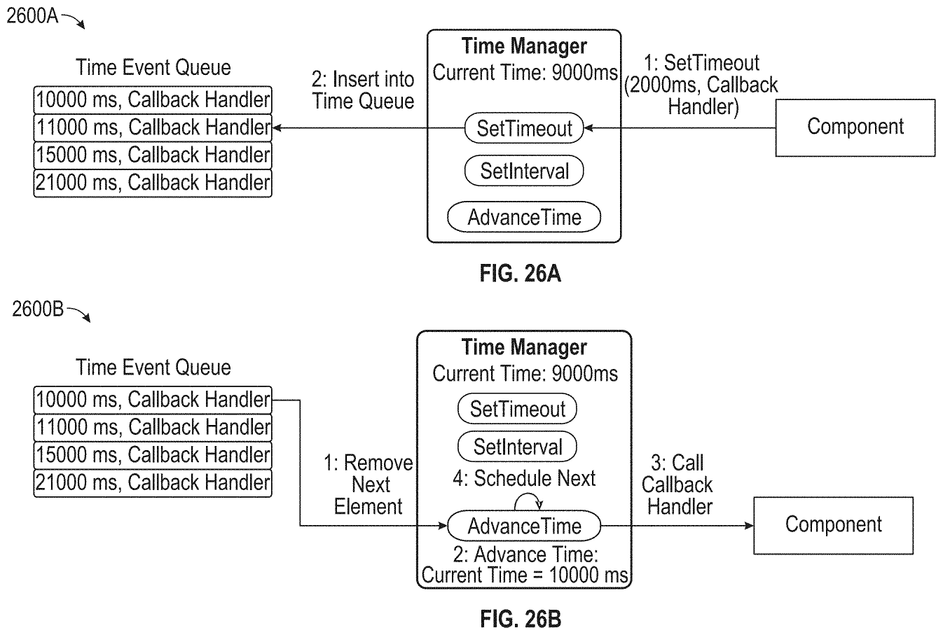

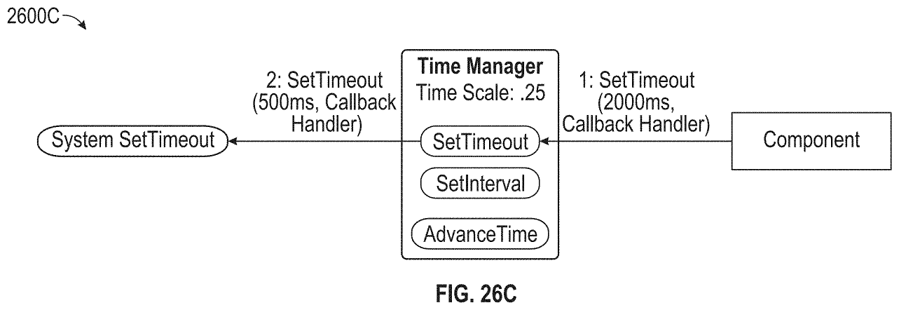

FIG. 26A-C illustrate time manager interfaces, in accordance with some embodiments of the present disclosure. In various embodiments, the models described herein may include time as a dimension, and the components in the model may have time-based behaviors; for instance, taking a certain amount of time to simulate work done, and have alerts that are generated after a certain amount of time. In some situations, it may be impractical to use real time to represent time in the model. If that were done, a model that simulates a process that takes a week to complete may take a week to execute. Instead, it would be advantageous to be able to disconnect time as represented in the model from time in the real world. This is implemented in the described platform via two options for handling of time in the model: Synthetic time and Scaled time.

When using Synthetic time on the described platform, time in the model is completely simulated and is disconnected from time in the real world. The platform keeps track of the current simulated time in the model, and all timed events that are to occur in the ‘future’. When there are no more events to process for the current model time, the platform jumps the model time forward to the next timed event to be processed, updating the current model time accordingly, and proceeds to process the timed event. Using this technique, there is no artificial waiting for events to be processed, and the model executes as quickly as theoretically possible. When the platform records model execution data, it correlates the data to the simulated model time, so all execution results will have accurate time data. In one embodiment, the time measurements may be more accurate than if the model time were based on real time, because when using real time, any delays caused by the time it takes for the CPU to execute the model may show up in the recorded time data, which may not happen when using Synthetic time.

FIG. 26A depicts how the platform manages timed events within the model.

A Time Manager replaces the standard Node.js setTimeout, setInterval, and other time-related call. The Time Manager is owned by a Universe, and is injected into each Component by the Universe. The Time Manager keeps track of the current simulated time in the model, e.g., 9000 ms in FIG. 26A. The Time Manager also keeps a queue of future time events to be executed, ordered by the future model time for each event.

When a new timed event is to be added, such as a timeout, the component calls the setTimeout( ) method in the Time Manager with the duration for the timeout, 2000 ms in this case. The Time Manager may further add the current time to the timeout duration, and create a new entry in the ordered time event queue it manages.

FIG. 26B depicts how future timed events are processed by the Time Manager. In one embodiment, the advanceTime method is invoked each Node.js event loop. It removes the next element from the time event queue. The Time Manager advances its current time to equal the timed event that was removed. The Time Manager calls the handler attached to the time event, which may be a function within the component that called setTimeout to add the time event. The Time Manager schedules the advanceTime method to be called again on the next Node.js event loop.

In one embodiment, Scaled Time may still utilize real time for timed events within the model, but may scale model time to be a factor of real time; either slowing time in the model down, or speeding it up relative to real time. When using Scaled Time, the Time Manager may be configured with a time scale, which may be a factor by which to scale the model time relative to real time.

FIG. 26C depicts what happens when a timed event is to be recorded. In one embodiment, Component calls the Time Manager setTimeout( ) method. The Time Manager then scales the passed in duration using the configured time scale, then calls the system setTimeout, passing in the scaled duration.

Flexible Time Handling may be configured via a Universe, which in turn governs one or more components. The components receive the Time Manager from the Universe, which they then use to schedule timed events, to read the current time, or perform any other time-related operations. In one embodiment, time Handling may be configured by populating at least one of the following configuration values into the Universe: time:scale—The time scale, or factor by which to multiply durations in timed events from components. If this is set, it indicates that scaled time is being used; time:synthetic—If set to any non-null value, this is an indication that synthetic time is to be used. This may be mutually exclusive with time:scale; and time—Starting time for the Universe, in milliseconds. If this is not provided, but either time:scale or time:synthetic is provided, time may be assumed to start at Oms.

In one embodiment, the described platform automatically saves models as changes are made. In one embodiment, the last time that the model was saved may be displayed in the top right of the model design screen, with the label “Last save.” If there was a failure in trying to save (e.g., due to the internet connection being down), the platform may display a save error message in place of, or in addition to, the last save time.

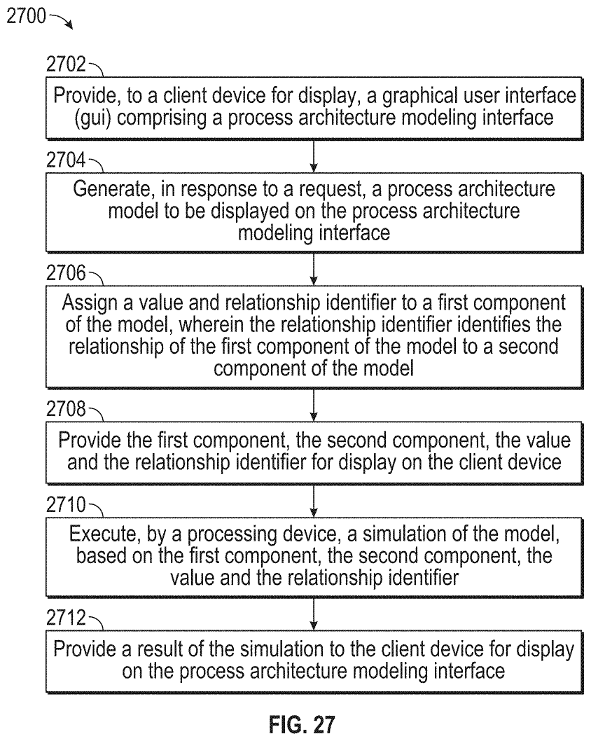

FIG. 27 is a flow diagram of a method 2700 illustrating process architecture modeling platform operations, in accordance with some embodiments of the present disclosure.

The method 2700 may be performed by processing logic that comprises hardware (e.g., circuitry, dedicated logic, programmable logic, microcode, etc.), software (e.g., instructions run on a processing device to perform hardware simulation), or a combination thereof. In embodiments, aspects of method 2700 may be performed by architecture 100 of FIG. 1 (e.g., on client device 100, cloud private network 102, and client network 103).

With reference to FIG. 27, method 2700 illustrates example functions used by various embodiments. Although specific function blocks (“blocks”) are disclosed in method 2700, such blocks are examples. That is, embodiments are well suited to performing various other blocks or variations of the blocks recited in method 2700. It is appreciated that the blocks in method 2700 may be performed in an order different than presented, and that not all of the blocks in method 2700 may be performed.

Block 2702 of method 2700 begins with processing logic providing, to a client device for display, a graphical user interface (GUI) comprising a process architecture modeling interface. In one embodiment, the process architecture modeling interface may be thought of a graphical canvas, upon which a model may be built. At block 2704, processing logic may generate, in response to a request (e.g., from a client device), a process architecture model to be displayed on the process architecture modeling interface. In one embodiment, the process architecture model may initially be blank. In another embodiment, the model may be a template selected from a plurality of template models in a template model library, wherein the template includes one or more predetermined components related to a particular subject matter. In one embodiment, templates may be edited. For example, processing logic may receive a request to modify the template and, in response to receiving the request, modify the template according to a parameter of the request. Advantageously, this may allow a user to start with a model template similar to one he or she would like to create and make modifications to the template to better suit the desired application.

At block 2706, processing logic assigns a value and relationship identifier to a first component of the model. In one embodiment, the relationship identifier identifies the relationship of the first component of the model to a second component of the model. For example, the relationship identifier may correspond to an input or an output of the first component leaded to an input or output of the second component or one or more other components, or even one or more components of a separate model.

At block 2708, processing logic provides the first component, the second component, the value, and the relationship identifier for display on the client device. In one embodiment, the process architecture modeling interface is kept up to date, displaying the latest changes to the model. In one embodiment, after a change has been made to any element of a model, processing logic may automatically save the model to one or more servers and display a time that the model was last saved.

At block 2710, processing logic executes, by a processing device, a simulation of the model, based on the first component, the second component, the value, and the relationship identifier. The simulation of the model may take into account the above parameters, and other rules that govern the behavior of individual components of the model. In one embodiment, such rules may be defined on a per-component bases, or may be globally defined in a universe and applied to members of such universe. For example, in one embodiment, the first component is associated with a first universe and the second component is associated with a second universe, wherein each component may have its own rule set, as well as distinct rule sets provide by their respective universes. Furthermore, parameters may be associated with universes, such that the parameters are globally visible to any element with permission to view data of the respective universe.

At block 2712, processing logic may provide a result of the simulation to the client device for display on the process architecture modeling interface. Furthermore, processing logic may analyze the result to determine an optimal solution. In one embodiment, processing logic may automatically (e.g., without human intervention) modify a model, based on a result of executing the model and a known objective (e.g., using machine learning or other techniques). In one embodiment, processing logic may iteratively modify and execute the model to achieve an optimal result. Advantageously, the execution of the model may be performed in real time or in simulated time, to increase the efficiency of executing long duration models.

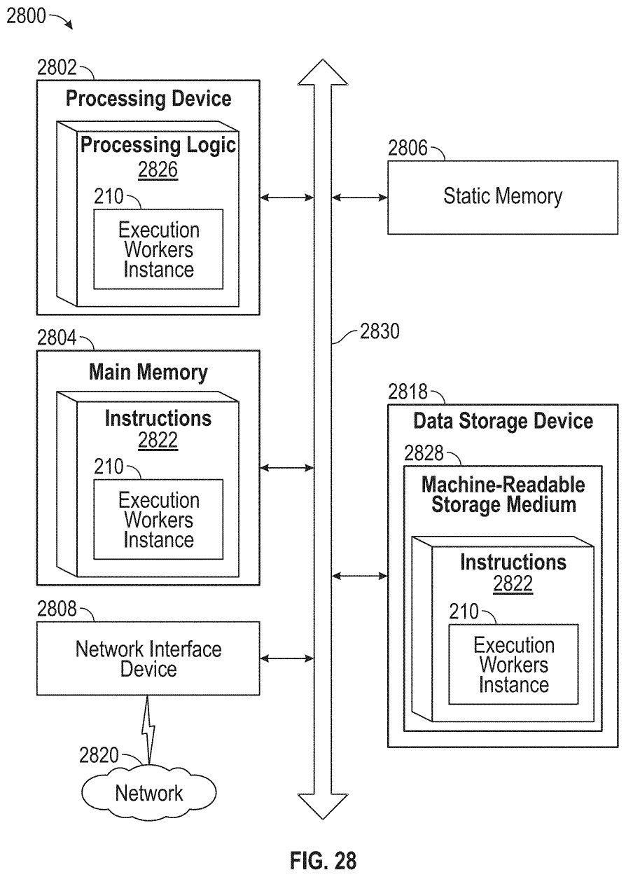

FIG. 28 is a block diagram of an example apparatus that may perform one or more of the operations described herein, in accordance with some embodiments. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 2800 may be representative of one or more servers, such as those described with respect to architecture 100 configured to perform the operations described herein.

The exemplary computer system 2800 includes a processing device 2802, a main memory 2804 (e.g., read-only memory (ROM), flash memory, dynamic random access memory (DRAM), a static memory 2806 (e.g., flash memory, static random access memory (SRAM), etc.), and a data storage device 2818, which communicate with each other via a bus 2830. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 2802 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 2802 may also be one or more special-purpose processing devices such as an application specific integrated circuit (ASIC), a field programmable gate array (FPGA), a digital signal processor (DSP), network processor, or the like. The processing device 2802 is configured to execute processing logic 2826, which may be one example of execution workers instance 210 of FIG. 2, for performing the operations and steps discussed herein.

The data storage device 2818 may include a machine-readable storage medium 2828, on which is stored one or more set of instructions 2822 (e.g., software) embodying any one or more of the methodologies of functions described herein, including instructions to cause the processing device 2802 to execute execution workers instance 210. The instructions 2822 may also reside, completely or at least partially, within the main memory 2804 or within the processing device 2802 during execution thereof by the computer system 2800; the main memory 2804 and the processing device 2802 also constituting machine-readable storage media. The instructions 2822 may further be transmitted or received over a network 2820 via the network interface device 2808.

The machine-readable storage medium 2828 may also be used to store instructions to perform a method for multi-level task debugging, as described herein. While the machine-readable storage medium 2828 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

1. A method comprising:
providing, to a client device for display, a graphical user interface (GUI) comprising a process architecture modeling interface;
generating, in response to a request, a process architecture model to be displayed on the process architecture modeling interface;
assigning a value and relationship identifier to a first component of the model, wherein the relationship identifier identifies a relationship of the first component of the model to a second component of the model;
providing the first component, the second component, the value, and the relationship identifier for display on the client device;
executing, by a processing device, a plurality of theoretical parallel simulations of the model, based on the first component, the second component, the value, the relationship identifier, and at least one additional value;
selecting an optimal simulation of the plurality of theoretical parallel simulations based on a known objective of the model; and
providing the optimal simulation to the client device for display on the process architecture modeling interface.

2. The method of claim 1, wherein the model is a template selected from a plurality of template models in a template model library.

3. The method of claim 2, further comprising:
receiving a request to modify the template; and
in response to receiving the request, modifying the template according to a parameter of the request.

4. The method of claim 1, further comprising in response to modifying the model, saving the model to a server.

5. The method of claim 1, wherein the relationship identifier corresponds to an input or an output of the first component.

6. The method of claim 1, wherein the executing the simulation of the model is performed in real time.

7. The method of claim 1, wherein the executing the simulation of the model is performed in synthetic time.

8. The method of claim 1, wherein the first component is associated with a first universe and the second component is associated with a second universe.

9. A system comprising:
a memory to store a value and a relationship identifier; and
a processing device, operatively coupled to the memory, to:
provide, to a client device for display, a graphical user interface (GUI) comprising a process architecture modeling interface;
generate, in response to a request, a process architecture model to be displayed on the process architecture modeling interface;
assign the value and the relationship identifier to a first component of the model, wherein the relationship identifier identifies the relationship of the first component of the model to a second component of the model;
provide the first component, the second component, the value, and the relationship identifier for display on the client device;
execute a theoretical simulation of the model, based on the first component, the second component, the value, and the relationship identifier; and
provide a result of the theoretical simulation to the client device for display on the process architecture modeling interface.

10. The system of claim 9, wherein the model is a template selected from a plurality of template models in a template model library.

11. The system of claim 10, the processing device further to:
receive a request to modify the template; and
in response to receiving the request, modify the template according to a parameter of the request.

12. The system of claim 9, the processing device further to: in response to modifying the model, saving the model to a server.

13. The system of claim 9, wherein the relationship identifier corresponds to an input or an output of the first component.

14. The system of claim 9, wherein the executing the simulation of the model is performed in real time.

15. The system of claim 9, wherein the executing the simulation of the model is performed in synthetic time.

16. The system of claim 9, wherein the first component is associated with a first universe and the second component is associated with a second universe.

17. A non-transitory computer-readable storage medium including instructions that, when executed by a processing device of a storage system, cause the processing device to:
provide, to a client device for display, a graphical user interface (GUI) comprising a process architecture modeling interface;
generate, in response to a request, a process architecture model to be displayed on the process architecture modeling interface;
assign a value and a relationship identifier to a first component of the model, wherein the relationship identifier identifies the relationship of the first component of the model to a second component of the model;
provide the first component, the second component, the value, and the relationship identifier for display on the client device;
execute, by the processing device, a theoretical simulation of the model, based on the first component, the second component, the value, and the relationship identifier; and
provide a result of the theoretical simulation to the client device for display on the process architecture modeling interface.

18. The non-transitory computer-readable storage medium of claim 17, wherein the model is a template selected from a plurality of template models in a template model library.

19. The non-transitory computer-readable storage medium of claim 18, the processing device further to:
receive a request to modify the template; and
in response to receiving the request, modify the template according to a parameter of the request.

20. The non-transitory computer-readable storage medium of claim 17, wherein the executing the simulation of the model is performed in synthetic time.
